(19) United States
(12) Patent Application Publication
(10) Pub. No.: US 2002/0120884 A1
(43) Pub. Date: Aug. 29, 2002

(54) Multi-computer fault detection system

(76) Inventors: Tetsuaki Nakamikawa, Hitachi (JP); Masahiko Saito, Mito (JP); Takanori Yokoyama, Hitachi (JP); Hiroshi Ohno, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 09/928,309

(22) Filed: Aug. 14, 2001

(30) Foreign Application Priority Data
Feb. 26, 2001 (JP) 2001-50484

(51) Int. Cl. G06F 11/26

(52) U.S. Cl. 714/31

(57) ABSTRACT

The present invention provides a multi-computer fault detection system comprising a plurality of computers in communication with each other, the computers comprising, a processor, a plurality of operating systems executed by the processor and a main memory for storing a task executed on one of the operating systems wherein the monitoring is whether a fault has occurred in another one of the operating systems wherein at least one of the computers with the fault alerts another one of the computers.

### FIELD OF THE INVENTION

The present invention relates to a computer system, in particular, a multi-computer fault detection system utilizing a plurality of operating systems (“OSs”) for detecting a fault in each computer.

### DISCUSSION OF THE RELATED ART

Conventionally, to provide computer services with high reliability, multi-computer systems have been generally adopted in which a plurality of computers are arranged so that service can be continued even if a single computer has failed due to a fault in the computer. Faults occurring in a computer can be divided generally into two types, hardware and software. In both cases, the ongoing processing is taken over if a fault is detected. There is a high risk that a hardware fault would occur in equipment such as a disk drive or a cooling fan, which have many moving part therein. However, multiplexing of these hardwares is relatively easy and, therefore, has been adopted for server PCs recently, decreasing the possibility of the occurrence of a system-down due to a hardware fault. But, most software faults are attributed to software bugs. With recent large-scale systems, completely removing all bugs is almost impossible. Among these bugs, OS bugs are rarely detectable. But, if they appear, a serious failure is highly likely to result.

As a result, many multi-computer systems have been developed which may be divided generally into two types, namely, the “hot-standby type” and the “fault-tolerant type,” depending on takeover-time requirements. Takeover-time is the maximum allowable time taken from occurrence of a fault in a single computer to resumption of the interrupted service by a standby computer. Takeover-time can be divided into fault detection time and start-up time. The fault detection time is time taken to recognize the occurrence of a fault in the primary system, while the start-up time is the time taken for the secondary system to actually start processing as the primary system.

The hot-standby-type multi-computer system has been used in a case where the takeover-time requirements are relatively moderate. A hot-standby type generally comprises a primary system (operational system) which regularly transmits an existence notification signal (“heartbeat”) to a secondary system (standby system) which determines whether the primary system is properly operating based upon the signal. When the existence notification signal is no longer received, the secondary system determines that a fault has occurred in the primary system and takes over the processing from the primary system. However, in the case of severe takeover-time requirements, the fault-tolerant type system are utilized in which multiplexed computers are switched by use of hardware. However, the fault-tolerant type is expensive since it requires special hardware for operating the multiplexed computers in synchronization. Hence, the hot-standby-type system is preferred.

But, the primary system of a conventional hot-standby type system transmits an existence notification signal by regularly activating a monitoring task. Hence, only when the OS is properly running, can the task be activated to notify the secondary system of any application fault. However, if a software fault has occurred in the OS itself, it is not possible to activate the monitoring task, and therefore the secondary system can detect the fault in the primary system only by detecting cessation of the existence notification signal. This detection causes undue delay and increases fault detection time.

Furthermore, when the amount of work to be processed by the primary system is temporarily increased, the application OS may not be able to transmit an existence notification signal in time, which will initiate the takeover process. To prevent the takeover process from being initiated when no actual fault has occurred, as described above, the secondary system determines that fault has occurred in the primary system only when the existence notification signal ceases for more than a predetermined period of time.

### SUMMARY OF THE INVENTION

In view of the problems with the prior art, it is an object of the present invention to provide a multi-computer system of a hot-standby type having a fault detection time shorter than that of the conventional hot-standby type without using special hardware such as employed by the fault-tolerant type system.

In an object of the present invention a multi-computer fault detection system is provided comprising a plurality of computers in communication with each other, the computers comprising, a processor, a plurality of operating systems executed by the processor and a main memory for storing a task executed on one of the operating systems wherein the monitoring is whether a fault has occurred in another one of the operating systems wherein at least one of the computers with the fault alerts another one of the computers.

In another object of the present invention a multi-computer fault detection system is provided comprising a plurality of computers in communication with each other, the computers comprising, a processor, a plurality of operating systems executed by the processor and a main memory for storing a task executed on each of the operating systems wherein the monitoring is whether a fault has occurred in another one of the operating systems wherein at least one of the computers with the fault alerts another one of the computers.

In yet another object of the present invention a multi-computer fault detection system is provided comprising a plurality of computers in communication with each other, the computers comprising, a processor, a plurality of operating systems executed by the processor and a main memory for storing a task executed on a host operating system for monitoring a fault on one or more virtual operating systems executed on the host operating system wherein at least one of the computers with the fault alerts another one of the computers.

In an object of the present invention a method for fault detection in a multi-computer system comprising the steps of, providing a plurality of computers in communication with each other, the step of providing computers further comprising the steps of, providing a processor and providing a plurality of operating systems executed by the processor. The method further comprises the step of providing a main memory for storing a task executed on one of the operating systems wherein the monitoring is whether a fault has occurred in another one of the operating systems wherein at least one of the computers with the fault alerts another one of the computers.

In another object of the present invention a method for fault detection in a multi-computer system comprising the steps of providing a plurality of computers in communication with each other, the step of providing computers further comprising the steps of, providing a processor and providing a plurality of operating systems executed by the processor. The method further comprises the step of providing a main memory for storing a task executed on each of the operating systems wherein the monitoring is whether a fault has occurred in another one of the operating systems wherein at least one of the computers with the fault alerts another one of the computers.

In yet another object of the present invention a method for fault detection in a multi-computer system is provided comprising the steps of providing a plurality of computers in communication with each other, the step of providing computers further comprising the steps of, providing a processor and providing a plurality of operating systems executed by the processor. The method further provides the step of providing a main memory for storing a task executed on a host operating system for monitoring a fault on one or more virtual operating systems executed on the host operating system wherein at least one of the computers with the fault alerts another one of the computers.

### BRIEF DESCRIPTION OF THE DRAWINGS

The above advantages and features of the invention will be more clearly understood from the following detailed description which is provided in connection with the accompanying drawings.

FIG. 1 illustrates a first embodiment of the present invention;

FIG. 2 illustrates how two OSs divide hardware resources;

FIG. 3 illustrates the memory map of a main memory;

FIG. 4 illustrates areas for variables used to specify system states;

FIG. 5 is a flowchart showing the process flow of an existence notification task;

FIG. 6 is a flowchart showing the process flow of an application OS monitoring task;

FIG. 7 is a flowchart showing the process flow of an inter-system monitoring task;

FIG. 8 is a flowchart showing the process flow of a configuration control task when a fault has occurred in the other system;

FIG. 9 illustrates a second embodiment of the present invention;

FIG. 10 illustrates areas for variables used to specify system states according to the second embodiment;

FIG. 11 is a flowchart showing the process flow of a monitoring-OS existence notification task;

FIG. 12 is a flowchart showing the process flow of a monitoring-OS monitoring task;

FIG. 13 is a flowchart showing the process flow of an inter-system monitoring task on the application side;

FIG. 14 illustrates a third embodiment of the present invention; and

FIG. 15 illustrates a fourth embodiment of the present invention.

### DETAILED DESCRIPTION OF THE INVENTION

Exemplary embodiment of the present invention will be described below in connection with the drawings. Other embodiments may be utilized and structural or logical changes may be made without departing from the spirit or scope of the present invention. Like items are referred to by like reference numerals throughout the drawings.

Referring now to the drawings, the computer 10 comprises a processor 100 for executing a plurality of OSs, a main memory 101, an I/O control device 102, and a processor bus 103 connecting these devices. Communications adapters 105 and 106 and a disk control adapter 107 are connected to the I/O control device 102 through an expansion-board bus 104. An interrupt signal line 102 is connected between the I/O control device 102 and the processor 100.

The processor 100 includes a timer device 1001 for generating a timer interrupt at specified time intervals. The main memory 101 comprises: an application OS 510; a configuration control task 511 for determining whether this system operates as the primary system or this system stands by as the secondary system; an application task 512 executed on the configuration control task 511; an existence notification task 513 for notifying the monitoring OS whether the application OS is properly operating; a monitoring OS 520; an application OS monitoring task 521 executed on the monitoring OS 520; an inter-system monitoring task 522 for monitoring the operation state of the computer for the other system; and an OS switchover program 500 for switching between the two OSs 510 and 520 to be executed. Since the components of a computer 11 are the same as those of the computer 10, their explanation is omitted.

The two computers 10 and 11 are connected to a network 20 for applications through the communications adapters 105 and 115 respectively, and to a network 21 for monitoring, through the communications adapters 106 and 116 respectively. The two computers 10 and 11 are also connected to a shared disk device 30 through the disk control adapters 107 and 117 respectively so as to share data in the disk 30. In other words, an operating system for monitoring a fault in one computer communicates separately with a fault monitoring operating system of the other computer. The same is true for the application operating system as well.

The present embodiment makes a plurality of OSs coexist by use of a method employing a separate OS switchover program for distributing interrupts. In this method of making a plurality of OSs exist together, hardware resources to be controlled by a plurality of OSs are first divided at the time of initializing the computer. In operation, the plurality of OSs to be executed are switched by interrupts from the timer device or the I/O control device.

In the present embodiment, the monitoring OS 520 is a real-time OS, and it is assumed that an interrupt is guaranteed to be responded within a predetermined time. It is further assumed that the OS switchover program 500 gives priority to execution of the monitoring OS 520 over execution of the application OS 510. Therefore, when the application OS 510 and the monitoring OS 520 have received interrupts at the same time, the interrupt to the monitoring OS 520 is processed with priority.

Hence, the present invention relates to a computer system in which a plurality of computers are multiplexed, each operating while switching between or among its two or more operating systems. Specifically, in the computer system, computers 10 and 11 each having a plurality of OSs under control of an OS switchover program, wherein a monitoring OS 520 monitors a software fault in an application OS 510, and when such a fault has occurred, an inter-system monitoring task 522 immediately notifies or alerts the other system of the fault through a dedicated communication line. Since a fault can be detected without detecting cessation of a heartbeat, it is possible to reduce the takeover time.

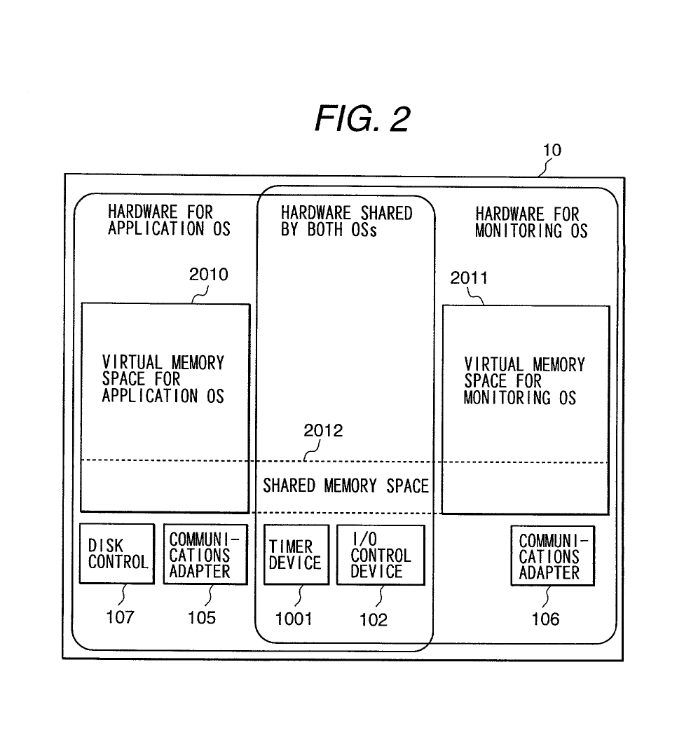

FIG. 2 conceptually shows how the two OSs divide the hardware resources. The application OS 510 has virtual memory space 2010, the disk control adapter 107, and the communications adapter 105 as hardware resources assigned solely to it. The monitoring OS 520 has virtual memory space 2011 and the communications adapter 106 as hardware resources. In addition, both OSs share shared memory space 2012, the timer device 1001, and the I/O control device 102.

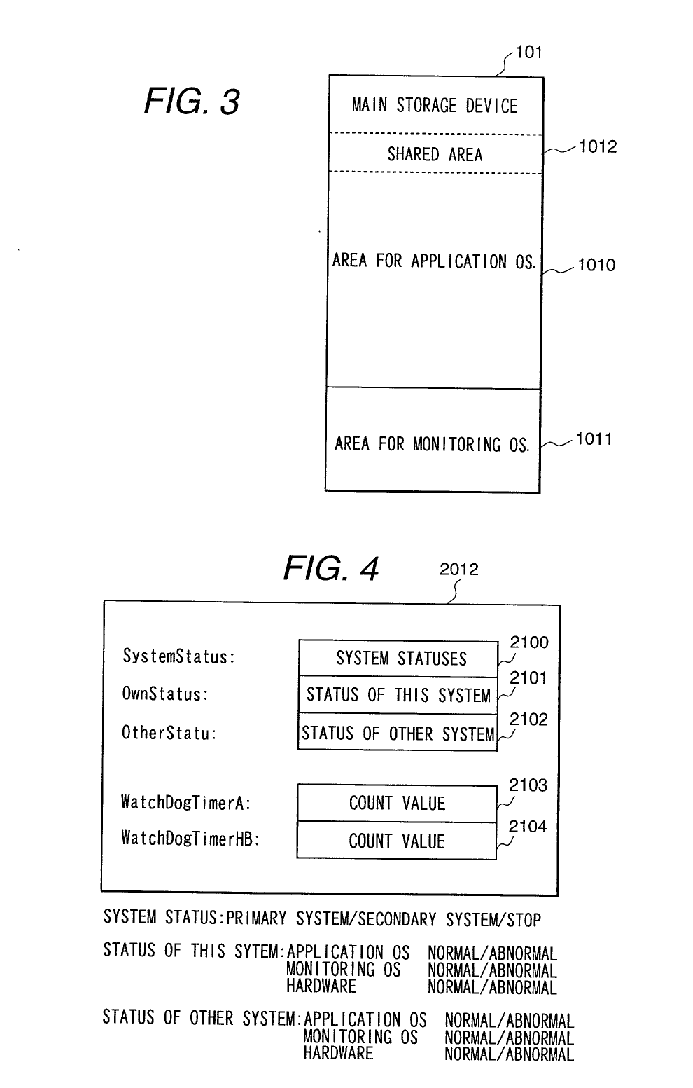

FIG. 3 schematically shows the memory map of the main memory 101. A real memory area 1010 is assigned to the virtual memory space 2010 of the application OS 510, while a real memory area 1011 is assigned to the virtual memory space 2011 of the monitoring OS 520. Furthermore, a real memory area 1012 is assigned to the shared memory space 2012.

FIG. 4 shows areas reserved in the shared memory space 2012 for storing variables used to specify system states. The SystemStatus variable 2100 indicates system states such as whether this computer is set as primary or secondary and whether the application is suspended. The OwnStatus variable 2101 indicates the operation states of this computer, such as whether the states of the application OS, monitoring OS, and hardware are each normal or abnormal. The OtherStatus variable 2102 indicates the operation states of the other computer.

The WatchDogTimerA variable 2103 is used to monitor the operation of the application OS, and stores a timer count value. The WatchDogTimerHB variable 2104 is used to monitor the state of processing of transmission received from the other system, and stores a timer count value.

The values of the SystemStatus variable 2100, the OwnStatus variable 2101, and the OtherStatus variable 2102 are updated by a configuration control task 511, an application OS monitoring task 521, and an inter-system monitoring task 522, respectively. The value of the WatchDogTimerA variable 2103 is updated by an existence notification task 513 and the application OS monitoring task 521, while the value of the WatchDogTimerHB variable 2104 is updated by the inter-system monitoring task 522.

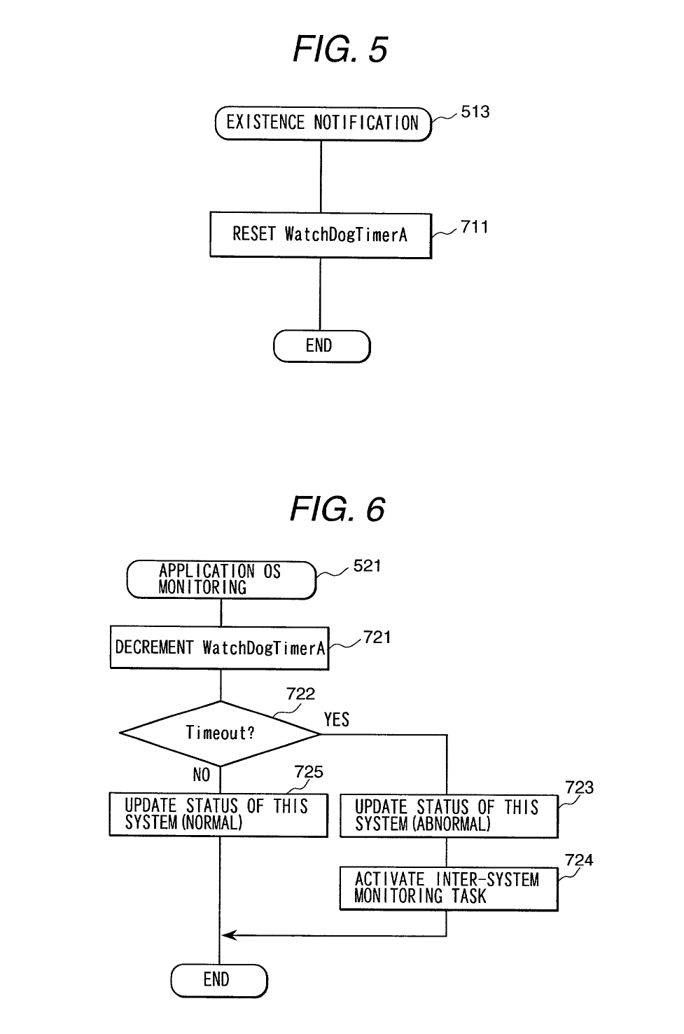

FIG. 5 shows the process flow of the existence notification task 513. At step 711, the WatchDogTimerA variable 2103 is reset to a predetermined value. The application OS 510 switches from one task to another to be executed upon receiving a timer interrupt or an interrupt from the I/O according to its task scheduling. At that time, the priority is so set that the existence notification task 513 is executed each time a timer interrupt is entered. With this arrangement, the existence notification task is regularly executed so long as the application OS 510 is properly processing interrupts and carrying out the scheduling.

Since the processing performed by the existence notification task imposes a load lighter than that of the conventional communication processing to the other system, it does not increase the entire system load even if performed each time the scheduler is activated by a timer interrupt. For example, conventional communication processing was carried out once every second. On the other hand, the existence notification task can be performed once every 10 milliseconds, making it possible to considerably reduce the fault detection time of a fault occurring in the application OS, as compared with the conventional system.

FIG. 6 shows the process flow of the application OS monitoring task 521. At step 721, the value of the WatchDogTimerA variable 2103 is incremented. Then, step 722 determines whether the incremented value is smaller than 0. If it is determined that the value is smaller than 0, the application OS should be timed out, and step 723 updates the OwnStatus variable 2101 to indicate that the application OS is abnormal and step 724 immediately activates the inter-system monitoring task 522. If it is determined that the value of the WatchDogTimerA variable 2103 is not smaller than 0, the OwnStatus variable 2101 is updated to indicate that the application OS is normal at step 725.

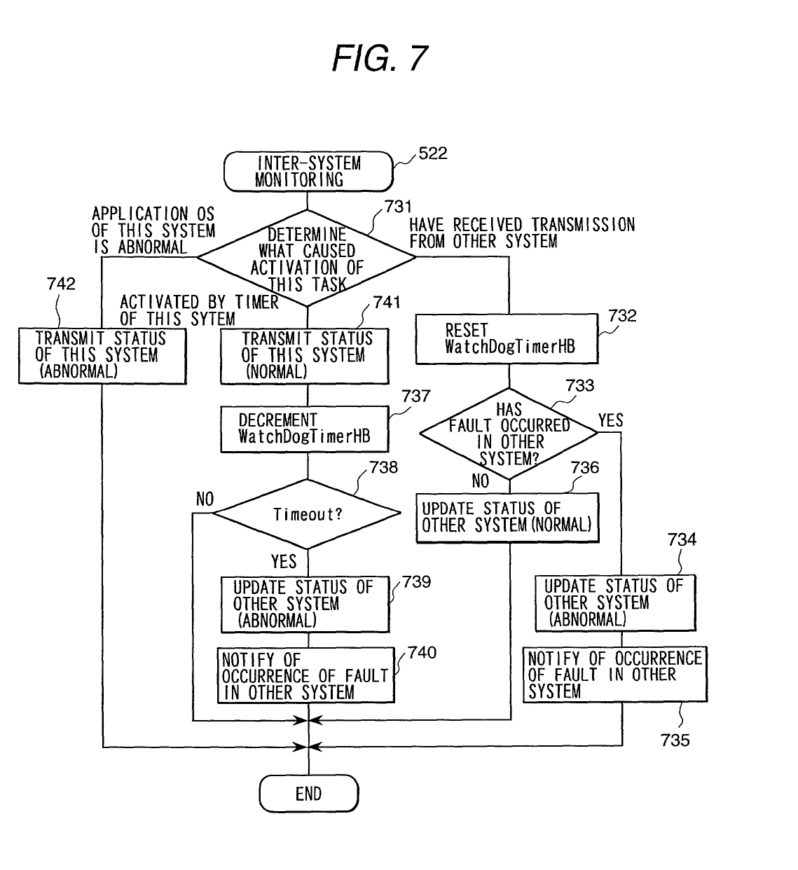

FIG. 7 shows the process flow of the inter-system monitoring task 522. At step 731, it is determined what the cause was for the activation of this task. If it is determined that the activation was caused by an interrupt from the I/O control device due to reception of transmission from the other system, the following process steps are performed. The WatchDogTimerHB variable 2104 is reset to a predetermined value at step 732 and it is determined from the received information whether a fault has occurred in the other system at step 733. Then, if it is determined that a fault has occurred in the other system, the OtherStatus variable 2102 is updated to indicate that the application OS is abnormal at step 734 and step 735 notifies the configuration control task 511 of the occurrence of the fault in the other system. If it is determined that no fault has occurred in the other system, the OtherStatus variable 2102 is updated to indicate that the application OS is normal at step 736.

On the other hand, if it is determined that the activation of the task 522 is a result of the regular activation by a timer interrupt, the following process steps are performed. The value of the OwnStatus variable 2101 is transmitted to the other system at step 741 and the value of the WatchDogTimerHB variable 2104 is incremented at step 737. Then, it is determined whether the incremented value is smaller than 0 at step 738 and if it is determined that the value is smaller than 0, the monitoring OS of the other system should have timed out, and the OtherStatus variable 2102 is updated to indicate that the monitoring OS is abnormal at step 739. Then, step 740 notifies the configuration control task 511 of occurrence of a fault in the other system. If it is determined that the activation of the task is caused by a notification by the application OS monitoring task 521 for this system of occurrence of a fault in the application OS, step 742 immediately transmits the value of the OwnStatus variable 2101 to the other system.

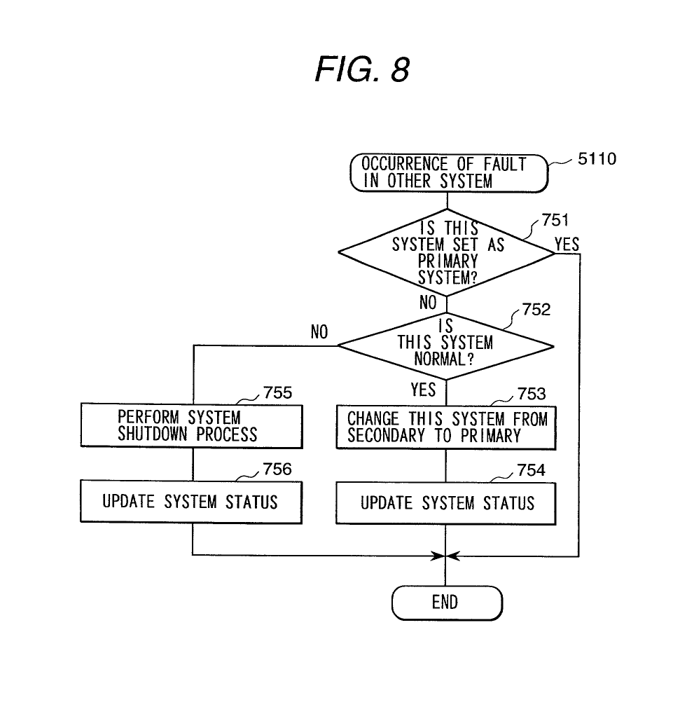

FIG. 8 shows the process flow of the configuration control task 511 when a fault has occurred in the other system. At step 751, it is determined whether this system is set as the primary system, and if it is the primary system, no further process step is required. If this system is not the primary system, it is determined whether this system is normal at step 752. If it is determined that this system is normal, this system is changed to the primary system and takes over the operation of the application at step 753, and the SystemStatus variable 2100 is updated to indicate that this system is primary at step 754. If this system is not normal, the system shutdown process is performed at step 755 since this system cannot take over the processing, and the SystemStatus variable 2100 is updated at step 756 to indicate that this system is shut down.

The computer 11 also performs the process steps described above. With this arrangement, the monitoring OS can monitor a software fault in the application OS, and when such a fault has occurred, the other system can be immediately notified of the fault, reducing the fault detection time. Furthermore, since the computers 10 and 11 comprise a communications adapter and a network and assigned to each OS, the monitoring OS can immediately notify whether a fault has occurred through its dedicated communications means.

Hence, the present invention provides a multi-computer fault detection system comprising a plurality of computers in communication with each other, the computers comprising, a processor, a plurality of operating systems executed by the processor and a main memory for storing a task executed on one of the operating systems wherein the monitoring is whether a fault has occurred in another one of the operating systems wherein at least one of the computers with the fault alerts another one of the computers.

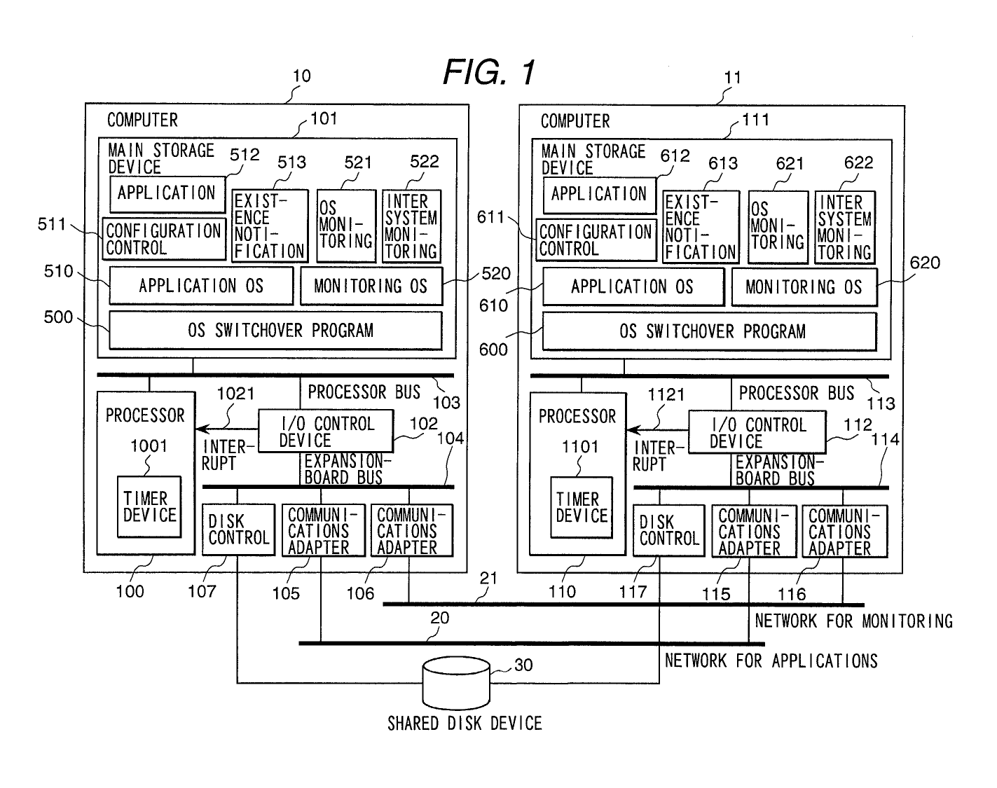

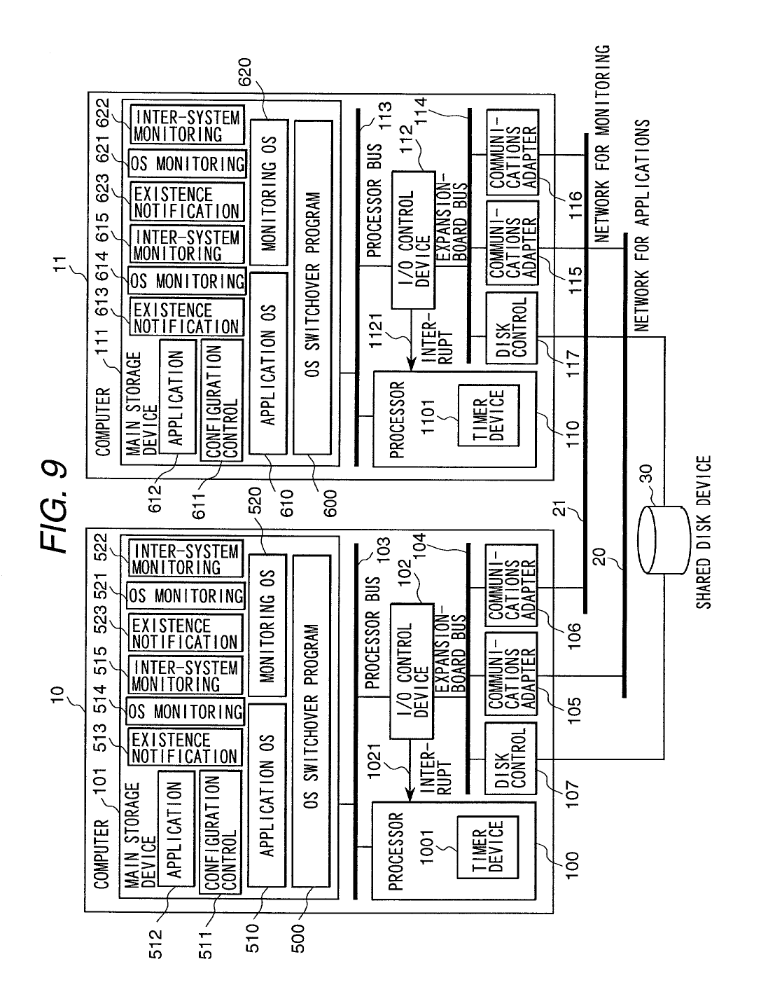

Next, a second embodiment of the present invention will be described with reference to FIG. 9. The system of FIG. 9 further comprises the following components to the configuration shown in FIG. 1: a monitoring-OS monitoring task 514 used for the application OS 510 to monitor the monitoring OS 520; an inter-system monitoring task 515 on the application side for performing inter-system monitoring by use of the network 20 for applications; a monitoring-OS existence notification task 523 for notifying the application OS 510 of the existence of the monitoring OS 520. The other components are the same as the components of the computer 10 shown in FIG. 1. The computer 11 in FIG. 9 is also added with the same tasks.

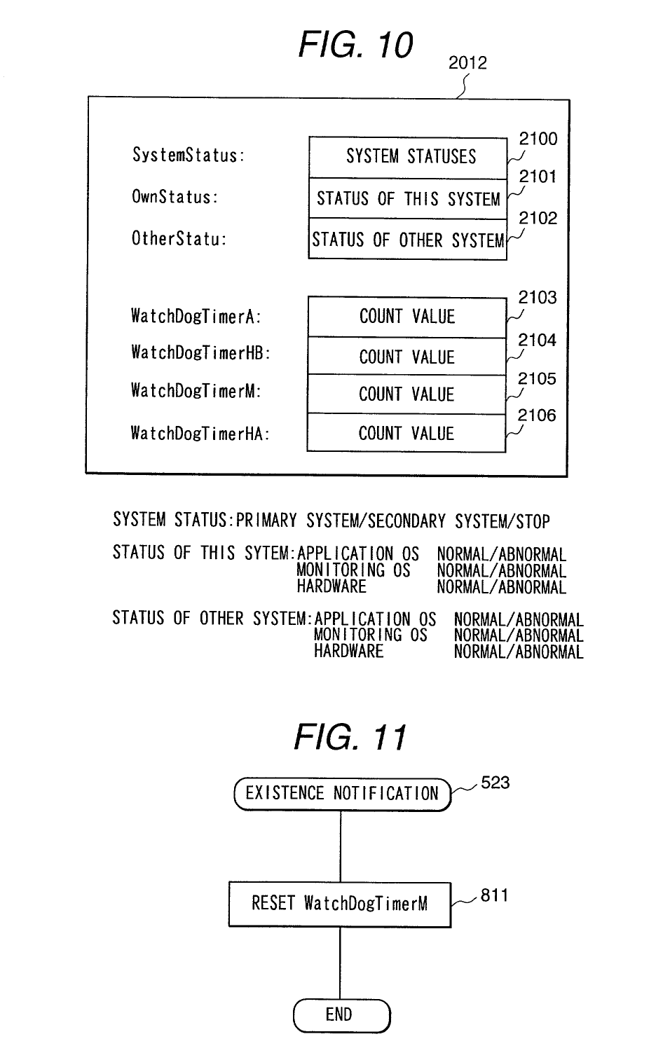

FIG. 10 shows areas reserved in the shared memory space 2012 for storing variables used to specify system states. The WatchDogTimerM variable 2105 is used to monitor the operation of the monitoring OS, and stores a timer count value. The WatchDogTimerHA variable 2106 is used to monitor the state of processing of transmission received from the other system through the network 20 for applications, and stores a timer count value. The value of the WatchDogTimerM variable 2105 is updated by the monitoring-OS existence notification task 523 and the monitoring-OS monitoring task 514, while the value of the WatchDogTimerHA variable 2106 is updated by the inter-system monitoring task 515 on the application side. The other areas for variables are the same as the areas shown in FIG. 4.

FIG. 11 shows the process flow of the monitoring-OS existence notification task 523. At step 811, the WatchDogTimerM variable 2105 is reset to a predetermined value. As is the case with the application OS 510, the monitoring OS 520 switches from one task to another to be executed upon receiving a timer interrupt or an interrupt from the I/O according to its task scheduling. At that time, the priority is set so that the task 523 is executed each time a timer interrupt is entered. With this arrangement, the OS existence notification task 523 is regularly executed so long as the monitoring OS 520 is properly processing interrupts and carrying out the scheduling.

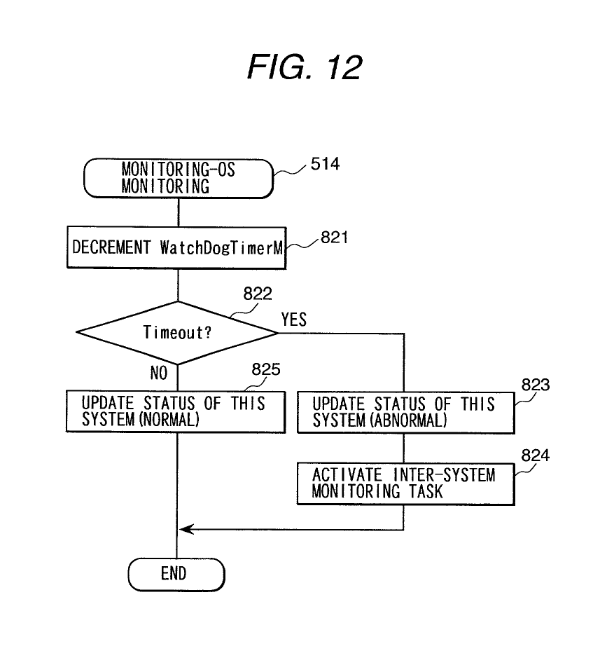

FIG. 12 shows the process flow of the monitoring-OS monitoring task 514. At step 821, the value of the WatchDogTimerM variable 2105 is incremented. Then, step 822 determines whether the incremented value is smaller than 0. If it is determined that the value is smaller than 0, the monitoring OS should have timed out, and step 823 updates the OwnStatus variable 2101 to indicate that the monitoring OS is abnormal and step 824 immediately activates the inter-system monitoring task 515 on the application side. If it is determined that the value of the WatchDogTimerM variable 2105 is not smaller than 0, the OwnStatus variable 2101 is updated to indicate that the monitoring OS is normal at step 825.

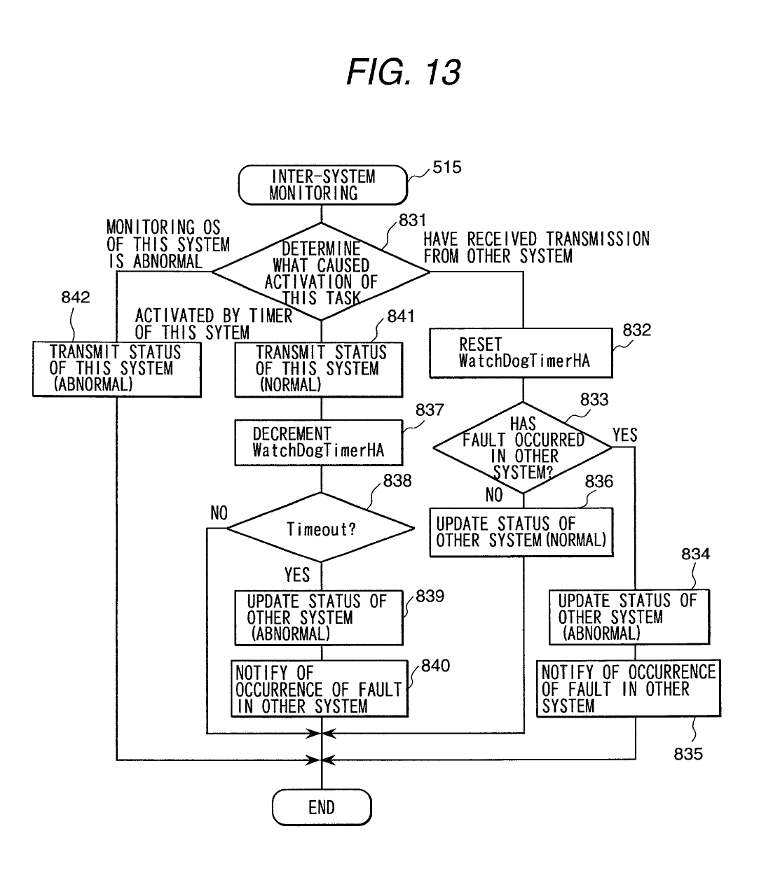

FIG. 13 shows the process flow of the inter-system monitoring task 515 on the application side. At step 831, it is determined what has caused the activation of this task. If it is determined that the activation was caused by an interrupt from the I/O control device due to reception of transmission from the other system, the following process steps are performed. The WatchDogTimerHA variable 2106 is reset to a predetermined value at step 832 and it is determined from the received information whether a fault has occurred in the other system at step 833. If it is determined that a fault has occurred in the other system, the OtherStatus variable 2102 is updated to indicate that the monitoring OS is abnormal at step 834 and step 835 notifies the configuration control task 511 of the occurrence of the fault in the other system. If it is determined that no fault has occurred in the other system, the OtherStatus variable 2102 is updated to indicate that the monitoring OS is normal at step 836.

But, if it is determined that the activation of the task is a result of the regular activation by a timer interrupt, the following process steps are performed. The value of the OwnStatus variable 2101 is transmitted to the other system at step 841 and the value of the WatchDogTimerHA variable 2106 is incremented at step 837. Then, it is determined whether the incremented value is smaller than 0 at step 838. If it is determined that the value is smaller than 0, the application OS of the other system should have timed out, and the OtherStatus variable 2102 is updated to indicate that the application OS is abnormal at step 839 and step 840 notifies the configuration control task 511 of the occurrence of the fault in the other system. If it is determined that the activation of the task was caused by a notification by the monitoring-OS monitoring task 514 for this system of occurrence of a fault in the monitoring OS, step 842 immediately transmits the value of the OwnStatus variable 2101 to the other system.

The computer 11 also performs the process steps described above. With this arrangement, the application OS also can monitor a software fault in the monitoring OS. Furthermore, there are provided two networks for inter-system monitoring, each under control of a different OS, enhancing the system reliability.

Hence, the present invention provides a multi-computer fault detection system comprising a plurality of computers in communication with each other, the computers comprising, a processor, a plurality of operating systems executed by the processor and a main memory for storing a task executed on each of the operating systems wherein the monitoring is whether a fault has occurred in another one of the operating systems wherein at least one of the computers with the fault alerts another one of the computers.

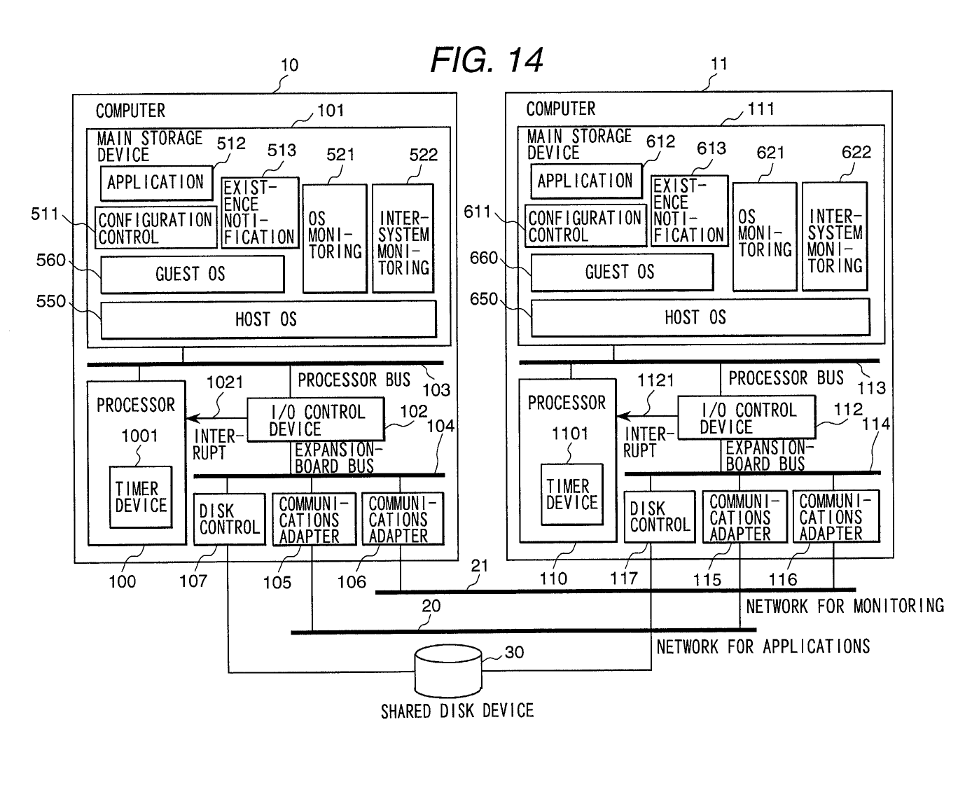

Next, a third embodiment of the present invention will be described with reference to FIG. 14. In the computer 10, a guest OS 560 runs on a virtual platform controlled by a host OS 550. Such a system is generally called “emulation”. Three tasks are executed on the guest OS 560: the configuration control task 511, the application task 512 executed on the configuration control task 511, and the existence notification task 513 for notifying the host OS of proper operation of the guest OS. On the other hand, two tasks are executed on the host OS 550, a guest OS monitoring task 521 and an inter-system monitoring task 522 for monitoring the operation state of the other computer. The operation of each task is the same as that for the first embodiment. The computer 11 also performs the same processing as described above.

With this arrangement, as in the first embodiment, the host OS can monitor a software fault in the guest OS, which is regarded as the application OS for this embodiment, and when a fault has occurred, the other system can be immediately notified of the fault, reducing the fault detection time.

Hence, the present invention provides a multi-computer fault detection system comprising a plurality of computers in communication with each other, the computers comprising, a processor, a plurality of operating systems executed by the processor and a main memory for storing a task executed on a host operating system for monitoring a fault on one or more virtual operating systems executed on the host operating system wherein at least one of the computers with the fault alerts another one of the computers.

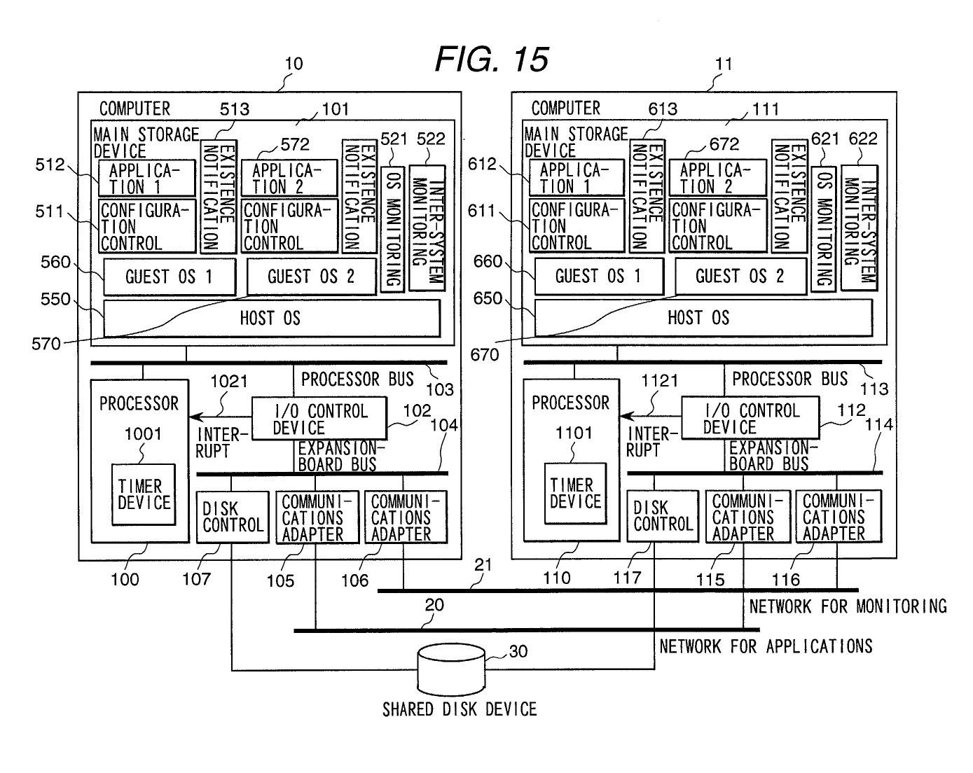

Next, a fourth embodiment of the present invention will be described with reference to FIG. 15. A first guest OS 560 and a second guest OS 570 run on a virtual platform controlled by a host OS 550. A first application task 512 is executed on the first guest OS 560, while a second application task 572 is executed on the second guest OS 570. A monitoring task 521 for monitoring the two guest OSs is executed on the host OS 550. The other tasks are the same as the tasks of the third embodiment. With this arrangement, a highly reliable system can be realized through multiplexing in the multi-OS environment in which a plurality of OSs each suitable for application(s) are employed on a single computer.

Hence, the present invention provides a multi-computer fault detection system comprising a plurality of computers in communication with each other, the computers comprising, a processor, a plurality of operating systems executed by the processor and a main memory for storing a task executed on a host operating system for monitoring a fault on one or more virtual operating systems executed on the host operating system wherein at least one of the computers with the fault alerts another one of the computers.

Although the invention has been described above in connection with exemplary embodiments, it is apparent that many modifications and substitutions can be made without departing from the spirit or scope of the invention. For instance, the communications adapter for the network for monitoring may be provided with a self-communication function using a microprocessor, and the memory area in the communications adapter may be provided with a watch dog timer (WatchDogTimer) function similar to that of the shared memory area employed in the present invention so as to make OSs coexist. Accordingly, the invention is not to be considered as limited by the foregoing description, but is only limited by the scope of the appended claims.

What is claimed as new and desired to be protected by Letters Patent of the United States is:

1. A multi-computer fault detection system comprising:
a plurality of computers in communication with each other, said computers comprising:
a processor;
a plurality of operating systems executed by said processor; and
a main memory for storing a task executed on one of said operating systems wherein said monitoring is whether a fault has occurred in another one of said operating systems wherein at least one of said computers with said fault alerts another one of said computers.

2. The system of claim 1 wherein said operating systems monitoring said fault is a real-time operating system.

3. The system of claim 1 wherein said another one of said operating systems is a non-real time operating system.

4. The system of claim 1 wherein said operating system monitoring said fault and said another one of said operating systems in one of said computers communicates separately with the same corresponding operating systems of another one of said computers.

5. The system of claim 1 wherein each said computer contains hardware shared by said operating systems.

6. The system of claim 1 wherein said main memory stores an operating system switchover program for switching between said plurality of operating systems when an interrupt signal is entered to said processor.

7. The system of claim 1 wherein each of said plurality of operating systems monitors said fault.

8. The system of claim 1 wherein said plurality of operating systems further includes a host operating system for monitoring fault on one or more virtual operating systems executed on said host operating system.

9. A multi-computer fault detection system comprising:
a plurality of computers in communication with each other, said computers comprising:
a processor;
a plurality of operating systems executed by said processor; and
a main memory for storing a task executed on each of said operating systems wherein said monitoring is whether a fault has occurred in another one of said operating systems wherein at least one of said computers with said fault alerts another one of said computers.

10. The system of claim 9 wherein said operating systems monitoring said fault is a real-time operating system.

11. The system of claim 9 wherein said another one of said operating systems is a non-real time operating system.

12. The system of claim 9 wherein said operating system monitoring said fault and said another one of said operating systems in one of said computers communicates separately with the same corresponding operating systems of another one of said computers.

13. The system of claim 9 wherein each said computer contains hardware shared by said operating systems.

14. The system of claim 9 wherein said main memory stores an operating system switchover program for switching between said plurality of operating systems when an interrupt signal is entered to said processor.

15. The system of claim 9 wherein said plurality of operating systems further includes a host operating system for monitoring fault on one or more virtual operating systems executed on said host operating system.

16. A multi-computer fault detection system comprising:
a plurality of computers in communication with each other, said computers comprising:
a processor;
a plurality of operating systems executed by said processor; and
a main memory for storing a task executed on a host operating system for monitoring a fault on one or more virtual operating systems executed on said host operating system wherein at least one of said computers with said fault alerts another one of said computers.

17. The system of claim 16 wherein said operating systems monitoring said fault is a real-time operating system.

18. The system of claim 16 wherein said another one of said operating systems is a non-real time operating system.

19. The system of claim 16 wherein said operating system monitoring said fault and said another one of said operating systems in one of said computers communicates separately with the same corresponding operating systems of another one of said computers.

20. The system of claim 16 wherein each said computer contains hardware shared by said operating systems.

21. The system of claim 16 wherein each of said plurality of operating systems monitors said fault.

22. A method for fault detection in a multi-computer system comprising the steps of:
providing a plurality of computers in communication with each other, said step of providing computers further comprising the steps of:
providing a processor;
providing a plurality of operating systems executed by said processor; and
providing a main memory for storing a task executed on one of said operating systems wherein said monitoring is whether a fault has occurred in another one of said operating systems wherein at least one of said computers with said fault alerts another one of said computers.

23. The method of claim 22 wherein said operating systems monitoring said fault is a real-time operating system.

24. The method of claim 22 wherein said another one of said operating systems is a non-real time operating system.

25. The method of claim 22 wherein said operating system monitoring said fault and said another one of said operating systems in one of said computers communicates separately with the same corresponding operating systems of another one of said computers.

26. The method of claim 22 wherein each said computer contains hardware shared by said operating systems.

27. The method of claim 22 wherein said main memory stores an operating system switchover program for switching between said plurality of operating systems when an interrupt signal is entered to said processor.

28. The method of claim 22 wherein each of said plurality of operating systems monitors said fault.

29. The method of claim 22 wherein said plurality of operating systems further includes a host operating system for monitoring fault on one or more virtual operating systems executed on said host operating system.

30. A method for fault detection in a multi-computer system comprising the steps of:
providing a plurality of computers in communication with each other, said step of providing computers further comprising the steps of:
providing a processor;
providing a plurality of operating systems executed by said processor; and
providing a main memory for storing a task executed on each of said operating systems wherein said monitoring is whether a fault has occurred in another one of said operating systems wherein at least one of said computers with said fault alerts another one of said computers.

31. The method of claim 30 wherein said operating systems monitoring said fault is a real-time operating system.

32. The method of claim 30 wherein said another one of said operating systems is a non-real time operating system.

33. The method of claim 30 wherein said operating system monitoring said fault and said another one of said operating systems in one of said computers communicates separately with the same corresponding operating systems of another one of said computers.

34. The method of claim 30 wherein each said computer contains hardware shared by said operating systems.

35. The method of claim 30 wherein said main memory stores an operating system switchover program for switching between said plurality of operating systems when an interrupt signal is entered to said processor.

36. The method of claim 30 wherein said plurality of operating systems further includes a host operating system for monitoring fault on one or more virtual operating systems executed on said host operating system.

37. A method for fault detection in a multi-computer system comprising the steps of:
providing a plurality of computers in communication with each other, said step of providing computers further comprising the steps of:
providing a processor;
providing a plurality of operating systems executed by said processor; and
providing a main memory for storing a task executed on a host operating system for monitoring a fault on one or more virtual operating systems executed on said host operating system wherein at least one of said computers with said fault alerts another one of said computers.

38. The method of claim 37 wherein said operating systems monitoring said fault is a real-time operating system.

39. The method of claim 37 wherein said another one of said operating systems is a non-real time operating system.

40. The method of claim 37 wherein said operating system monitoring said fault and said another one of said operating systems in one of said computers communicates separately with the same corresponding operating systems of another one of said computers.

41. The method of claim 37 wherein each said computer contains hardware shared by said operating systems.

42. The method of claim 37 wherein each of said plurality of operating systems monitors said fault.
